(19) United States
(12) Patent Application Publication
(10) Pub. No.: US 2006/0172209 A1
(43) Pub. Date: Aug. 3, 2006

(54) Toner for developing electrostatic image and method of forming image using the same

(75) Inventor: Hiroto Kidokoro, Tokyo (JP)

Correspondence Address: BIRCH STEWART KOLASCH & BIRCH, PO BOX 747, FALLS CHURCH, VA, 22040-0747, US

(73) Assignee: ZEON CORPORATION

(21) Appl. No.: 11/341,523

(22) Filed: Jan. 30, 2006

(30) Foreign Application Priority Data
Jan. 31, 2005 (JP) 2005-024602

(51) Int. Cl. G03G 9/097

(52) U.S. Cl. 430/108.2; 430/111.4; 430/111.41; 430/110.2; 430/124

(57) ABSTRACT

An object of the present invention is to provide a toner for developing electrostatic image which has excellent charging property and flowability and is less likely to decline image quality due to an environmental change.

A toner for developing electrostatic image comprises a colored particle containing a binder resin, a colorant, a release agent and a charge control agent, wherein an absolute charge amount of the toner on a developing roll in an actual device |Q/M|ₐ is in the range from 20 to 100 μC/g and a zeta potential |E| is 10 mV or less after laying still for 24 hours under environment at a temperature of 23° C. and a relative humidity of 50%.

### BACKGROUND OF THE INVENTION

1. Field of the Invention

The present invention relates to a toner for developing an electrostatic image. Particularly, the present invention relates to a toner for developing an electrostatic image excellent in charging property and flowability as well as having small decline in image quality due to environmental changes (hereinafter it may be referred as “a toner for developing an electrostatic image” or simply “a toner”).

Also, the present invention relates to a method of forming an image using the toner for developing an electrostatic image.

2. Description of the Related Art

In an image forming device such as an electrophotography device, an electrostatic recording device and the like, a latent image of electrostatics is formed on a photosensitive member, which is developed by a toner so as to form a visible image (an image formed by the toner). Then, the image obtained by the toner is transferred on a transferring material such as paper, an OHP sheet and the like, followed by being fixed by means of heating, pressuring, solvent-steaming and the like.

Recently, an image forming device is increasingly sophisticated. It has been demanded to realize high resolution and high speed at the same time by, for example, a method of forming a latent image of electrostatics by a laser or the like. Hence, it has been demanded for a toner to realize smaller particle size and sharpness in particle distribution so as to be able to attain a high resolution and also to realize a low fixing temperature so as to be able to form an image by a high speed device. On the other hand, there are more cases that the image forming device is used in a high-temperature and humidity area. Thus, it has been demanded to improve stability of an image density, flowability and storage stability of a toner, and the like.

In the image forming device, conventionally, a toner obtained by pulverization, which is produced in such a manner that after a thermoplastic resin containing a colorant, a charge control agent or the like is melted and mixed to disperse uniformly, the resulting mixture is pulverized and classified, has been mainly used. However, the toner produced by the pulverization method is difficult to control a particle diameter and requires the classification operation, which makes the production processes of the toner cumbersome. Also, a fine powder remains on the surface of the toner obtained by pulverization. Due to the influence of the fine powder, image quality declines in response to the change of absolute charge amount, and a toner with excellent flowability and shelf stability were not obtained.

In order to solve the above-mentioned problem, a method for producing a toner by a so-called polymerization method is suggested. For example, Japanese Patent Application Laid-Open (JP-A) No. Hei. 6-273,977 discloses a method for producing a toner for developing electrostatic image comprising a step of suspension polymerization, wherein after a polyolefin wax is subject to wet pulverization in a polymerizable monomer, a colorant is added, mixed and dispersed. The toner obtained by the production method has a good fixing ability and developing ability, and has a good durability without generating filming on a photosensitive member and a developing blade. However, further improvement in durability under high-temperature and humidity environment is desired.

Also, as aforementioned, it is required for a toner to be able to fix at lower fixing temperature in order to cope with a high-speed device. If a large amount of a softening agent is contained in a toner to lower a fixing temperature, there were problems such that the shelf stability is impaired and, at the same time, image quality declines when stored for a long period. In order to solve the problem, a toner having a layer formed (encapsulated) on the outer side of a polymerized toner is proposed. For example, JP-A No. Hei. 11-72,949 corresponding to U.S. Pat. Nos. 6,025,106 and 6,054,245 discloses a developer comprising a polymerized particle and an external additive obtained in a specific method, water extract of which has pH of 4 to 7. The developer disclosed in the above document can be fixed at low temperature, and flowability, long-period shelf stability and charge stability are improved by encapsulation. However, as aforementioned, recently, there are more cases that a toner is used in a high-temperature and humidity area. Performances such as low-temperature fixing ability, flowability, shelf stability, charge stability and the like need to be further improved. Hence, in a case of storing a conventional encapsulated toner containing a release agent having a low softening point (temperature) and a charge control agent having a polar group for a long period under high temperature and humidity, it is required to further decrease a decline of image density and generation of a fog.

JP-A No. Hei. 4-217,267 discloses a toner for developing electrostatic image, wherein a flowability improving agent, in which a zeta potential at pH 5 is controlled, is attached to the surface of the colored particle. The document discloses that the toner for developing electrostatic image has small change in friction charge amount under the condition of the lower temperature and humidity toward the higher temperature and humidity, and the toner can attain a clear image density and a good tone. However, the toner for developing electrostatic image disclosed in the document has a problem of high fixing temperature or the like.

JP-A No. 2004-301,990 discloses a toner which has a specific thermally-stimulated current value and a specific melting characteristic, intending to provide a toner which can be fixed at a low temperature but does not generate hot offset, has a good shelf stability, and does not generate a fog even if a lasting print test is performed for a long period. The toner disclosed in the document can be fixed at a low temperature but has a high offset generating temperature, has a good shelf stability, and generates less fog even if a lasting print test is performed for a long period. On the other hand, further improvement in these properties and prevention of deterioration in printing property upon storing the toner under a high-temperature and humidity environment are desired.

There are a positive charging photosensitive member and a negative photosensitive member according to the charge polarity of the surface of the photosensitive member. The charge polarity relates to a material used for a photosensitive layer formed on the photosensitive member. An inorganic photosensitive member using inorganic material such as selenium, silicon and the like is mostly a positive charging photosensitive member. Recently, a negative charging organic photosensitive member is mainly used, thus, as a photosensitive member, a negative charging photosensitive member is generally used. However, recently, as an environmental measure against the problem of generating ozone, which easily occurs in the case of the negative charging photosensitive member, the positive charging organic photosensitive member, which generates less ozone, is reassessed.

### SUMMARY OF THE INVENTION

An object of the present invention is to provide a toner for developing electrostatic image which has excellent charging property and flowability and is less likely to decline image quality due to an environmental change.

As a result of diligent researches made to attain the above object, the inventor of the present invention found out that a toner for developing electrostatic image having a specific range of absolute charge amount of the toner on a developing roll in an actual device and a specific range of zeta potential can attain the above object.

The present invention is based on the above knowledge and provides a toner for developing electrostatic image comprising a colored particle containing a binder resin, a colorant, a release agent and a charge control agent,

wherein an absolute charge amount of the toner on a developing roll in an actual device |Q/M|ₐ is in the range from 20 to 100 μC/g and

a zeta potential |E| is 10 mV or less

after laying still for 24 hours under environment at a temperature of 23° C. and a relative humidity of 50% (N/N environment).

The inventor of the present invention found out that, with the use of a toner having low zeta potential, a stable printing property can be obtained after storing a toner under high temperature. However, all conventional toners for developing electrostatic image have a zeta potential of 10 mV or more. When it is tried to obtain a toner having low zeta potential with the conventional technique, only a toner having lower absolute charge amount than the practical absolute charge amount of the toner on a developing roll in an actual device (20 to 100 μC/g) was obtained.

That is, if an absolute charge amount of the toner on a developing roll in an actual device |Q/M|ₐ and a zeta potential |E| after laying still for a day (24 hours) under an N/N environment are in the range of the present invention, charging on the surface of a colored particle is stabilized so that when the toner is stored under the N/N environment, not only an image with high quality can be obtained by also a stable image can be maintained when the toner is left at high temperature. Also, the toner is excellent in flowability and a fog is less generated.

It is preferable that the toner for developing electrostatic image has a positive charging property since generation of ozone, which is more likely to occur in a negative charging toner mainly used in recent years, less occurs.

It is preferable that a saturated absolute charge amount |Q/M|ₛ of the toner for developing electrostatic image is in the range from 30 to 120 μC/g and a saturated charge time of the toner for developing electrostatic image is 5 minutes or less. If the saturated absolute charge amount and the saturated charge time are in the above range, there is less generation of a fog, an initial charge speed of the toner is fast and stable image density can be obtained.

It is preferable that a volume average particle diameter (Dv) of the colored particle of the toner for developing electrostatic image is in the range from 4 to 10 μm and an average circle degree of the colored particle of the toner for developing electrostatic image is in the range from 0.950 to 0.995. If the volume average particle diameter and the average circle degree are in the above range, the toner is excellent in transferability, developing ability and thin line reproducibility.

It is preferable that the charge control agent of the colored particle of the toner for developing electrostatic image is a charge control resin, and each of base value and acid value of a THF-soluble component of the toner is 1 mgKOH/g or less. If the base value and acid value of a THF-soluble component is in the above range, a toner excellent in environmental stability can be obtained.

It is preferable that a base value of the charge control resin is 1.5 mgKOH/g or less since if the base value of the charge control resin is within the above range, generation of a fog less occurs.

It is preferable that the charge control agent of the colored particle of the toner for developing electrostatic image is a charge control resin, and the charge control resin is a copolymer containing a quaternary ammonium group as durability of the toner improves.

The colored particle of the toner for developing electrostatic image according to the present invention is preferably a core-shell structured particle since a balance between lowering of a fixing temperature and prevention of aggregation at storage can be taken.

Also, the present invention provides a method of forming an image comprising processes of:

a developing process to form a visible image by attaching the above-mentioned toner for developing electrostatic image to a latent image of electrostatics formed on a photosensitive member;

a transferring process to transfer the visible image onto a transferring material so as to form a transferred image; and

a fixing process to fix the transferred image.

In the method of forming an image of the present invention, it is preferable that the photosensitive member is a positive charging photosensitive member, which generates less ozone.

According to the present invention, a toner for developing electrostatic image which is excellent in charging property and flowability and, at the same time, which has small decline of image quality due to environmental change, that is, a toner for developing electrostatic image which is excellent in shelf stability is provided.

Also, according to the present invention, a method of forming an image using the above-metioned toner for developing electrostatic image is provided.

### BRIEF DESCRIPTION OF THE DRAWING

In the accompanying drawing,

FIG. 1 is a view showing a constitutional example of an image forming device, to which a toner for developing electrostatic image of the present invention is applied.

### DETAILED DESCRIPTION OF THE INVENTION

Hereinafter, a toner for developing electrostatic image of the present invention will be explained.

A toner for developing electrostatic image of the present invention contains a colored particle comprising a binder resin, a colorant, a charge control agent and a release agent.

As the binder resin, for example, there may be a resin which has been widely used as a binder resin for a toner, such as polystyrene, a styrene-butyl acrylate copolymer, a polyester resin, an epoxy resin and the like.

As the colorant, for example, there may be various kinds of pigments and dyes, such as carbon black, titanium black, magnetic particle and oil black.

As a black colorant, carbon black that has a primary particle diameter of 20 to 40 nm is suitably used since the carbon black having a particle diameter in the range can be dispersed uniformly in a toner and generation of a fog can be reduced.

In the case of producing a full color toner, a yellow colorant, a magenta colorant and a cyan colorant may be generally used.

As the yellow colorant, for example, a compound such as an azo based pigment, a condensation polycyclic pigment or the like may be used. Specifically, there may be C. I. Pigment Yellow 3, 12, 13, 14, 15, 17, 62, 65, 73, 74, 75, 83, 90, 93, 97, 120, 138, 155, 180, 181, 185, 186, 213 or the like.

As the magenta colorant, for example, a compound such as an azo based pigment, a condensation polycyclic pigment or the like may be used. Specifically, there may be C. I. Pigment Red 31, 48, 57, 58, 60, 63, 64, 68, 81, 83, 87, 88, 89, 90, 112, 114, 122, 123, 144, 146, 149, 150, 163, 170, 184, 185, 187, 202, 206, 207, 209, and 251, C. I. Pigment Violet 19 or the like.

As the cyan colorant, for example, a copper phthalocyanine compound, a derivative thereof, an anthraquinone compound or the like may be used. Specifically, there may be C. I. Pigment Blue 2, 3, 6, 15, 15:1, 15:2, 15:3, 15:4, 16, 17, 60 or the like.

An amount of the colorant is preferably 1 to 10 parts by weight with respect to a binder resin of 100 parts by weight.

As the charge control agent, there may not be particularly limited if it is a conventionally used toner. As the charge control agent, there are a negative charge control agent and a positive charge control agent. The charge control agent is selected depending on the toner to be obtained, whether the toner may be a negative charge toner or a positive charge toner. For example, a positive charging photosensitive member has an advantage that the generation of ozone is smaller than a negative charging photosensitive member. From this point of view, a toner of the present invention may be preferably a toner having a positive charging property.

Among charge control agents, a charge control resin is preferable since the charge control resin is well compatible with the binder resin, it is colorless, and a toner having a stable charging property can be obtained even at high-speed color continuous printing.

As the negative charge control resin, there may be a resin having a substituent group selected from the group consisting of a carboxyl group or a salt group thereof, a phenolic group or a salt group thereof, a thiophenolic group or a salt group thereof, and a sulfonic acid group or a salt group thereof, and the like. Specifically, a copolymer containing a sulfonic acid group (or a salt group thereof) such as those produced according to the disclosure in JP-A No. Hei 1-217,464 (U.S. Pat. No. 4,950,575) and JP-A No. Hei 3-15,858.

On the other hand, as the positive charge control resin, for example, there may be a resin containing an amino group such as NH₂, —NHCH₃, —N(CH₃)₂, —NHC₂H₅, —N(C₂H₅)₂, —NHC₂H₄OH and the like, and a resin containing a functional group wherein the above-mentioned amino group is ammonium chloridized. Specifically, for example, there may be a copolymer containing quaternary ammonium group (or salt group thereof) such as those produced according to the disclosure in JP-A No. Shou. 63-60,458 (U.S. Pat. No. 4,840,863), JP-A No. Hei 3-175,456, JP-A No. Hei 3-243,954 and JP-A No. Hei 11-15,192.

As the salt of the above substituent contained in the side chain of the polymer, there may be a salt with metal such as zinc, magnesium, aluminium, sodium, calcium, chromium, iron, manganese, cobalt and the like, and a salt with an organic salt group such as ammonium ion, pyridinium ion, imidazolium ion and the like.

As the positive charge control resin, a copolymer containing a quaternary ammonium group is preferably used since durability of the toner improves. The portion of monomer units having quaternary ammonium group may be preferably in the range from 0.1 to 15 wt %, and more preferably in the range from 0.3 to 10 wt % of all units constituting the positive charge control resin. If the content is in this range, the absolute charge amount of the toner for developing electrostatic image becomes easy to control and generation of a fog can be decreased.

The charge control resin may have a number average molecular weight preferably in the range from 3,000 to 30,000, more preferably in the range from 3,000 to 20,000, and most preferably in the range from 5,000 to 15,000. If the number average molecular weight is below the above range, offset tends to generates. To the contrary, if the number average molecular weight is beyond the above range, fixing ability tends to deteriorate.

The charge control resin may have a glass transition temperature preferably in the range from 40 to 80° C., more preferably in the range from 45 to 75° C., and most preferably in the range from 45 to 70° C. If the glass transition temperature is below the above range, the shelf stability of the toner tends to deteriorate. If the glass transition temperature is beyond the above range, fixing ability of the toner tends to decline.

The base value of the charge control resin is preferably 1.5 mgKOH/g or less, more preferably 1 mgKOH/g or less, and most preferably 0.5 mgKOH/g or less. If the base value of the charge control resin exceeds 1.5 mgKOH/g, a fog may generate.

The acid value of the charge control resin is preferably 5 mgKOH/g or less, more preferably 1 mgKOH/g or less, further preferably 0.5 mgKOH/g or less, and most preferably 0.1 mgKOH/g or less. If the acid value of the charge control resin is out of the above range, a fog may generate.

In the case of using the above-mentioned charge control resin, the amount of the above charge control resin added may be in the range from 0.02 to 0.20 wt %, more preferably 0.08 to 0.16 wt % with respect to the binder resin, when represented by ratio of monomer units having a functional group required for imparting charging property, for example, in the case of a negative charge control resin, by a ratio of monomer units (polymerization ratio) having a substituent group selected from the group consisting of the carboxyl group or the salt group thereof, the phenolic group or the salt group thereof, the thiophenolic group or the salt group thereof, and the sulfonic acid group or the salt group thereof, and the like.

If the amount of the functional group required for imparting charging property (charge functional group amount) is within the above range, the absolute charge amount of the toner becomes easy to control and generation of a fog can be decreased.

To the contrary, if the charge functional group amount is below the above range, a printing durability easily deteriorates and development may be deteriorated. If the charge functional group amount is beyond the above range, a fog may be easily generated.

The amount of the charge control agent may be generally 0.01 to 30 parts by weight with respect to 100 parts by weight of the binder resin, and preferably 0.3 to 25 parts by weight.

As the release agent, for example, there may be selected a polyolefin wax such as lower molecule polyethylene, lower molecule polypropylene, lower molecule polybutylene and the like; a natural wax such as candelilla, a carnauba wax, a rice wax, a natural wax, jojoba and the like; a petroleum wax such as paraffin, microcrystalline, petrolactam and the like, and a modified wax thereof; a synthesized wax such as a Fischer-Tropsch wax and the like; a multifunctional ester compound such as pentaerythritol tetramyristate, pentaerythritol tetrapalmitate, dipentaerythritol hexapalmitate, dipentaerythritol hexamyristate and the like.

The release agent may be used solely or in combination of two or more kinds.

Among the above release agents, the synthesized wax and the multifunctional ester compound are preferable. Among them, a multifunctional ester compound having an endothermic peak temperature upon temperature rising in the range from 30 to 150° C., more preferably 40 to 100° C., and most preferably 50 to 80° C., according to the DSC curve measured by means of a Differential Scanning Calorimetry (DSC), is preferable since a toner excellent in fixing-peeling (releasing characteristic) balance upon fixing can be obtained. Particularly, a multifunctional ester compound which has a molecular weight of 1,000 or more, dissolves by 5 parts by weight or more with respect to styrene of 100 parts by weight at 25° C., and has an acid value of 10 mgKOH/g or less is further preferable since such a multifunctional ester compound exhibits outstanding effect of low-temperature fixing ability. As such a multifunctional ester compound, dipentaerythritol hexapalmitate, pentaerythritol tetramyristate and dipentaerythritol hexamyristate are particularly preferable. The endothermic peak temperature refers to a value measured with reference to ASTM D3418-82.

The base value of the release agent is preferably 4 mgKOH/g or less, and more preferably 3 mgKOH/g or less. If the base value of the release agent exceeds 4 mgKOH/g, a fog may generate.

The amount of the release agent is generally 3 to 10 parts by weight, preferably 5 to 8 parts by weight, with respect to 100 parts by weight of the binder resin. If the amount of the release agent is within the above range, a balance between hot offset (releasing characteristic) and lowering of a fixing temperature can be taken.

Also, when the added amount (part by weight) of the release agent is “b” and the base value (mgKOH/g) of the release agent is “a” with respect to the binder resin of 100 parts by weight, it is preferable that product of “a” and “b” (a×b) may be 40 or less, and more preferably 30 or less. If the product of “a” and “b” exceeds 40, a fog may generate.

The colored particle comprising the toner for developing electrostatic image of the present invention may be a so-called core-shell structured (or “capsule type”) particle, which can be obtained from the combination of two different polymers in inner part of the particle (core layer) and in outer part of the particle (shell layer). The core-shell structured particle is preferable since a balance between lowering of a fixing temperature and prevention of aggregation at storage can be taken by covering a substance having low softening point of inner part (core layer) with a substance having higher softening point.

Generally, the core layer of the core-shell structured particle comprises the binder resin, the colorant, the charge control agent and the release agent, and the shell layer comprises the binder resin alone.

The weight ratio of the core layer and the shell layer of the core-shell structured particle may not be particularly limited. Generally, the weight ratio of the core layer and the shell layer (core layer/shell layer) of the core-shell structured particle may be in the range from 80/20 to 99.9/0.1.

The mean thickness of the shell layer of the core-shell structured particle may be generally in the range from 0.001 to 1.0 μm, preferably 0.003 to 0.5 μm, and more preferably 0.005 to 0.2 μm. If the thickness of the shell layer becomes larger than the above range, fixing ability may decrease. If the thickness of the shell layer becomes smaller than the above range, shelf stability may decline. It is not necessary that a whole surface of the core particle forming the core-shell structured colored particle is covered with the shell layer. There may be a core-shell structured colored particle having a part of the surface of a core particle covered with a shell layer.

The particle diameter of the core particle and the thickness of the shell layer of the core-shell structured particle can be obtained by directly measuring the size of a particle and the thickness of a shell layer of a particle selected at random from observed picture when it is possible to observe by means of a through scan mode electron microscope. If it is difficult to observe a core layer and a shell layer by means of the through scan mode electron microscope, the particle diameter of the core particle and the thickness of the shell layer of the core-shell structured particle can be calculated from a diameter of a core particle and an amount of monomers forming a shell layer used in production of a toner for developing electrostatic image.

A volume average particle diameter Dv of the colored particle comprising the toner for developing electrostatic image of the present invention may be preferably in the range from 4 to 10 μm, preferably 5 to 9 μm, more preferably 6 to 8 μm. If Dv is less than 4 μm, a flowability of the toner lowers, a fog may generate, a transferability of the toner lowers, and cleaning property may decline. If Dv is beyond 8 μm, thin line reproducibility may decrease.

A ratio (Dv/Dp) of a volume average particle diameter Dv and a number average particle diameter Dp of the colored particle comprising the toner for developing electrostatic image of the present invention may be preferably in the range from 1.0 to 1.3, more preferably 1.0 to 1.2. If Dv/Dp exceeds the above range, a fog may generate.

The volume average particle diameter and the number average particle diameter of the colored particle may be measured, for example, by means of a particle diameter distribution measuring device (trade name: multicizer; manufactured by Beckman Coulter, Inc.) or the like.

An average circle degree of the colored particle comprising the toner for developing electrostatic image of the present invention may be in the range from 0.950 to 0.995, and preferably from 0.970 to 0.985. If the average circle degree of the colored particle is below the above range, the thin line reproducibility may be inferior. On the other hand, if the average circle degree of the colored particle exceeds the above range, cleaning property becomes easy to decline.

By producing the toner for developing electrostatic image in a method such as a phase inversion emulsifying method, a solution suspension method, a polymerization method (a suspension polymerization method or an emulsion polymerization method) and the like, the average circle degree of the colored particle can be easily within the above range.

The average circle degree of the colored particle may be measured by means of a flow particle image analyzer.

In the present invention, the circle degree is defined as a ratio of a circumference of a circle having the same projected area as that of a particle image and a perimeter of a projected image of the particle. Also, the average circle degree in the present invention is used as a simple method to represent the form of the particle quantitatively, and is an index showing the degree of convex and concave of the colored particle. The average circle degree shows “1” when a colored particle is completely a sphere, and shows smaller value when the surface form of the colored particle has more convex and concave. The average circle degree (Ca) is a value obtained by the following formula:

$$Average circle degree {C}_{a} = ( {\sum }_{i = 1}^{n} ( {C}_{i} ⨯ {f}_{i} ) ) / {\sum }_{i = 1}^{n} ( {f}_{i} )$$

In the above formula, “n” is a number of particle, circle degree Ci of which is obtained.

In the above formula, “Ci” is a circle degree of each particle calculated by the following formula based on the circumference measured for each particle of a particle group of 0.6 to 400 μm by a diameter of the equivalent circle.

Circle degree (Ci)=a circumference of a circle having an equal projected area as that of a particle/a perimeter of a projected image of the particle

In the above formula, “fi” is a frequency of the particle having the circle degree Ci. The circle degree and the average circle degree can be measured by means of a flow particle image analyzer (product name: FPIA-2100 or FPIA-2000, manufactured by Sysmex Corporation) and the like.

As a toner, the colored particle may be used as it is for developing electrophotography. Also, the colored particle, an external additive and, if required, other particles may be mixed by means of a high-speed agitator such as a Henshcel mixer or the like to form a one-component toner in order to control a charging property, flowability, shelf stability or the like of the toner.

Further, in addition to the colored particle, the external additive and other particles, if required, a carrier particle such as ferrite, iron powder or the like may be mixed by various known methods to form a two-component toner.

The external additive is a fine particle having smaller diameter than the colored particle used for adjusting a charging property, flowability, shelf stability or the like of the toner, and is attached or buried on the surface of the colored particle.

As the external additive, generally, there may be an inorganic particle and an organic resin particle used for the purpose of improving flowability and charging property of a toner. A particle to be added as the external additive has a smaller mean particle diameter than that of the colored particle. For example, as the inorganic particle, there may be a particle of silica, aluminum oxide, titanium oxide, zinc oxide, tin oxide or the like. As the organic resin particle, there may be a particle of a methacrylate ester polymer particle, an acrylate ester polymer particle, a styrene-methacrylate ester copolymer particle, a styrene-acrylate ester copolymer particle, or a core-shell structured particle, the core layer of which is a styrene polymer and the shell layer of which is a methacrylate ester polymer, or the like. Among the above, the particle of silica and the particle of titanium oxide may be suitable. A particle of silica or titanium oxide, the surface of which is subjected to a hydrophobicity-imparting treatment may be preferable. A particle of silica which is subjected to a hydrophobicity-imparting treatment is particularly preferable. An amount of the external additive may not be particularly limited, but may be generally 0.1 to 6 parts by weight with respect to 100 parts by weight of the colored particle.

The toner for developing electrostatic image of the present invention is a toner for developing electrostatic image comprising the colored particle containing the binder resin, the colorant, the release agent and the charge control agent, wherein an absolute charge amount of the toner on a developing roll in an actual device |Q/M|ₐ is in the range from 20 to 100 μC/g and a zeta potential |E| is 10 mV or less after laying still for a day (24 hours) under environment at a temperature of 23° C. and a relative humidity of 50% (N/N environment). The zeta potential is preferably 5 mV or less, more preferably 2 mV or less.

The environment at a temperature of 23° C. and a relative humidity of 50% (N/N environment) in the present invention is a condition specified to represent temperature and humidity of a general indoor environment.

If the absolute charge amount of the toner on a developing roll in an actual device |Q/M|ₐ and the zeta potential |E| after laying still for a day (24 hours) under the N/N environment are in the above range, charging of the surface of the colored particle stabilizes and when the toner is stored in the N/N environment, not only an image having high quality can be obtained but also a stable image can be maintained when the toner is left in high temperature. Also, the colored particle is excellent in flowability and generation of a fog decreases.

The toner for developing electrostatic image is excellent in charging property and flowability, and has small decline in image quality due to an environmental change.

The zeta potential in the present invention (it may be also referred as “electrokinetic potential”) is a potential difference at an interface between a static phase facing a colored particle surface and a solvent for measurement in a colored particle surface-solvent interface of a formed electric double layer.

A toner having low zeta potential |E| as the above range is considered that charge of a toner surface tends to be less influenced by various environmental changes, particularly humidity.

The zeta potential |E| can be measured by, for example, a laser Doppler method, also known as an electrophoretic light scattering measurement method. In the case that a particle dispersed in a liquid is charged, if an electric field is applied to the system, the particle moves toward an electrode, wherein the transfer rate of the particle is proportional to the charge of the particle. Hence, by measuring the transfer rate of the particle, the zeta potential of the particle can be obtained. In the laser Doppler method, a migration rate (transfer rate) of the particle is obtained by utilizing “Doppler effect” which can be seen in the situation that when light or acoustic wave hits a moving object and reflects or scatters, frequency of light and acoustic wave changes proportional to the transfer rate of the object. When radiating the electrophoretic particle with a laser light, the frequency of the scattered light from the particle shifts due to the Doppler Effect. Since the shift amount is proportional to the migration rate of the particle, the migration rate of the particle can be obtained by measuring the shit amount.

Electric mobility (U) can be obtained from the obtained migration rate (V) and electric field (E) using the following formula (1):
U=V/E (1)

The zeta potential (ζ) can be obtained from the electric mobility (U) using the following formula (2) (Smoluchowski equation):
ζ=4ΠηU/ε (2)

In the formula (2), η and ε refer to the following:

η: viscosity of a solvent

ε: conductivity of a solvent

In the present invention, a mixed liquid (50/50 based on capacity, 25° C.) of ethanol and ion-exchange water is used to obtain the zeta potential. The η is 0.993 mPa and ε is 52.0.

A value of the zeta potential is, as mentioned above, a function of viscosity and conductivity of a solvent. Since the value of the zeta potential is easily influenced by an ion present in the solvent and pH of the solvent, measurement is preformed with pH 6.5 to 7.5. A conductivity of the ion-exchange water used for the zeta potential measurement may be preferably 10 μS/cm or less, more preferably 1 μS/cm or less. In order to accurately measure the zeta potential of the toner, a solvent, which enables that no bubble is generated on the surface of the toner upon mixing the toner with a solvent for measurement, and the surface of the toner is sufficiently moistened, is used. In the case that a bubble is generated on the surface of the toner, a small amount of a neutral surfactant may be added to the solvent, or an ultrasonic wave treatment may be performed after mixing the toner with the solvent, in order to improve wettability of the toner and the solvent.

The absolute charge amount of the toner on a developing roll in an actual device in the present invention is an absolute charge amount of a toner of use situation. That is, a measured value of an absolute charge amount per unit weight of a toner filled in an image forming device such as a printer or the like under a certain environment, agitated in the device, and provided on a developing roll in the charged condition. The absolute charge amount of the toner on a developing roll in an actual device may be in the range from 20 to 100 μC/g, preferably 20 to 80 μC/g, more preferably 30 to 70 μC/g.

If the absolute charge amount of the toner on a developing roll in an actual device is within the above range, development can be uniform, image density stabilizes and an image without a fog can be obtained.

For example, an absolute charge amount of a toner can be evaluated by mounting a cartridge filled with a toner on a commercially available non-magnetic one-component printer (positive charge organic photosensitive development dram; printing speed: 22 prints (A4 size sheet) per minute) under the N/N environment at a temperature of 23° C. and a relative humidity of 50%. That is, after the first sheet of plain pattern printing is performed by means of the non-magnetic one-component printer, the second sheet of the plain pattern printing is halted in the middle of printing to measure an absolute charge amount (μC/g) of the toner developed on the photosensitive member by means of, for example, a suction type Q/m analyzer (product name: 210HS-2A; manufactured by TREK JAPAN).

The toner of the present invention is preferable to have a positive charging property.

If the toner has a positive charging property, effects of the present invention due to the zeta potential and the absolute charge amount of the toner on a developing roll in an actual device in the range defined in the present invention can be remarkably exhibited. Also, in the case of the positive charge toner, there is an advantage that generation of ozone, which easily generates in the negative charging toner mainly used in recent years, is small.

It is preferably that the saturated absolute charge amount |Q/M|ₛ of the toner for developing electrostatic image of the present invention is in the range from 30 to 120 μC/g and the saturated charge time of the toner for developing electrostatic image of the present invention is 5 minutes or less. The saturated absolute charge amount |Q/M|ₛ may be more preferably in the range from 30 to 110 μC/g, further preferably 40 to 110 μC/g, and most preferably 40 to 85 μC/g. The saturated charge time may be more preferably 3 minutes or less.

If the saturated absolute charge amount and the saturated charge time of the toner are within the above range, an initial charge speed of the toner is excellent, a fog is hardly generated, and an excellent image density can be obtained.

The saturated charge time in the present invention means time that an absolute charge amount per unit weight of a toner reaches saturated in the process of charging the toner such as agitation or the like. An absolute charge amount when the absolute charge amount reaches saturation is referred as the saturated absolute charge amount.

The saturated charge time and the saturated absolute charge amount |Q/M|ₛ of the toner can be measured by a blowoff measuring method. First, 59.7 g of a carrier particle made of ferrite powder and 0.3 g of a toner are charged into a stainless (SUS) pot having a capacity of 200 cc followed by agitation for 30 minutes with rotation at 150 rpm to frictionally charge the toner. Next, the toner is blown off at 1 kg/cm nitrogen pressure to measure an absolute charge amount (Q/M) per unit weight. For the measurement, for example, a blowoff charge measuring instrument (product name: TB-200; manufactured by Toshiba Chemical Corporation) can be used.

As the carrier particle made of ferrite powder, a manganese based ferrite powder is preferable, particularly, a manganese based ferrite powder, the surface of which is covered with a silicon resin and carbon black (for example, product name: NZ-3; manufactured by Powdertech Corporation), may be preferably used.

The saturated absolute charge amount is obtained in the following manner. Absolute charge amounts are measured by increasing blowoff time by 30 seconds, and time when change of the absolute charge amounts (Q/M) becomes 10% or less is referred as a saturated charge time. This measurement is conducted twice, and a mean value of two measurements of absolute charge amount at the saturated charge time is obtained as the saturated absolute charge amount.

It is preferable that the charge control agent of the toner for developing electrostatic image of the present invention is a charge control resin, and each of base value and acid value of a THF-soluble component of the toner is 1 mgKOH/g or less.

The THF-soluble component of the toner comprises a soluble product in the binder resin component, the release agent component and the charge control resin component. The quantitative determination of base value and acid value of the THF-soluble component of the toner can be an index of the contained amount of an acid group or a hydroxyl group in the toner.

If the base value and the acid value of the THF-soluble component in the toner are within the above range, a toner excellent in environmental stability can be obtained. On the other hand, if base value or acid value exceeds the above range, the environmental stability of the toner declines and decline of an image quality may be caused.

The base value of the THF-soluble component of the toner in the present invention can be obtained in the following manner. Firstly, after 1 g of a toner is dissolved in 100 ml of tetrahydrofuran (THF) followed by suction filtration by means of a filter paper to remove insolvable components, the obtained solution is further filtered by means of a filter having a pore size of 0.45 μm. Next, the filtrate is titrated with 0.01 N methyl isobutyl ketone (MIBK) perchlorate solution. From the amount of MIBK perchlorate solution required to neutralize, the base value (mgKOH/g) of the toner is obtained.

For the titration, an automatic potentiometric titrator (product name: AT-500N; manufactured by Kyoto Electronics Manufacturing Co., Ltd.) with an electrode (product name: #100-C172; manufactured by Kyoto Electronics Manufacturing Co., Ltd.) may be used. As 0.01 N MIBK perchlorate solution, 0.1 N dioxane perchlorate solution (for non-aqueous titration, manufactured by Kishida Chemical Co., Ltd.) diluted by MIBK to have 10 times thinner concentration can be used. The measurement is performed under nitrogen atmosphere so as to avoid influence of moisture and carbon dioxide in the air.

The acid value of the toner of the present invention can be obtained as follows. Firstly, after 1 g of a toner is dissolved in 100 ml of THF followed by suction filtration by means of a filter paper to remove insolvable components, the obtained filtrate is further filtered by means of a filter having a pore size of 0.45 μm. Next, 20 ml of methyl isobutyl ketone (MIBK) solution of 0.01 N tetrabutyl ammonium hydroxide (TBAH) is added to the filtrate followed by titration with 0.01 N MIBK perchlorate solution. From the amount of MIBK perchlorate solution required to neutralize, the acid value (mgKOH/g) of the toner is obtained.

As the MIBK solution of 0.01 N TBAH, 30% methanol solution of TBAH (for non-aqueous titration; manufactured by Tokyo Kasei Kogyo Co., Ltd.) diluted with MIBK can be used. As 0.01 N MIBK perchlorate solution, 0.1 N dioxane perchlorate solution (for non-aqueous titration, manufactured by Kishida Chemical Co., Ltd.) diluted by MIBK to have 10 times thinner concentration can be used. The titrator used for titration to obtain base value may be similarly used and similar operation may be performed.

It is preferable that the amount of elution of ionic material of the medium is small since even if a small amount of the ionic material remains in the surface or inside of the toner for developing electrostatic image of the present invention, there is an influence on stability of an image density. From this point of view, it is preferable in the toner for developing electrostatic image of the present invention that conductivity σ2 of an aqueous extract solution is 20 μS/cm or less, more preferably 10 μS/com or less, obtained in such a manner that after the toner is dispersed in ion-exchanged water having conductivity σ1 of 0 to 10 μS/cm to have a concentration of 6 wt % followed by heating and boiling for 10 minutes, separately boiled same ion-exchanged water having conductivity σ1 is added to complement vaporized moisture and make same capacity as the original capacity, and cooled to room temperature (around 25° C.). Also, the difference of σ2 and σ1 (σ2−σ1) may be preferably 10 μS/cm or less, more preferably 6 μS/cm or less. If the conductivity σ2 exceeds 20 μS/cm, dependency on environment of absolute charge amount becomes higher so as to cause decline in image quality due to environmental changes (change in temperature and humidity). If σ2−σ1 exceeds 10 μS/cm, dependency on environment of absolute charge amount also becomes higher so as to cause decline in image quality due to environmental changes (change in temperature and humidity).

The toner for developing electrostatic image of the present invention may be produced by a method of producing a toner such as a polymerization method (a suspension polymerization method or an emulsion polymerization agglomeration method), a solution suspension method, a pulverization method and the like, when kinds and amounts of the charge control resin or release agent, and kinds of monomers are controlled.

Next, a method for producing the colored particle comprising the toner for developing electrostatic image by the suspension polymerization method will be explained. The colored particle comprising the toner for developing electrostatic image of the present invention can be produced in the following manner. A colorant, a charge control resin, a release agent, a chain transfer agent and further, if required, other additives are dissolved or dispersed in a polymerizable monomer, which is material of a binder resin, to obtain a polymerizable monomer composition. The polymerizable monomer composition is charged with an aqueous dispersion medium containing a dispersion stabilizer, thereto a polymerization initiator is added followed by polymerization, thus obtained a particle. Further, if required, a polymerizable monomer may be added to the obtained particle followed by polymerization to form a shell layer. Then, filtration, washing, dewatering and drying are preformed so as to obtain a colored particle of the present invention.

As the polymerizable monomer, for example, there may be a monovinyl monomer, a crosslinkable monomer, macromonomer or the like. The polymerizable monomer is polymerized and becomes the binder resin component. Herein, “(meth)acrylate” refers to “acrylate” or “methacrylate”.

As the monovinyl monomer, for example, there may be a phenolic vinyl monomer such as styrene, vinyl toluene, α-methyl styrene or the like; (meth)acrylic acid; a (meth)acrylic monomer such as methyl(meth)acrylate, ethyl(meth)acrylate, propyl(meth)acrylate, butyl(meth)acrylate, 2-ethylhexyl (meth)acrylate, cyclohexyl(meth)acrylate, isobornyl (meth)acrylate or the like; a monoolefin monomer such as ethylene, propylene, butylene or the like.

The monovinyl monomer may be used alone or in combination of more than one monomer. Among the above monovinyl monomers, the phenolic vinyl monomer alone, a combination of the phenolic vinyl monomer and the (meth)acrylate monomer or the like is suitably used.

If the crosslinkable monomer is used together with the monovinyl monomer, hot offset can be effectively improved. The crosslinkable monomer means a monomer having two or more vinyl groups. As the crosslinkable monomer, for example, there may be divinyl benzene, divinyl naphthalene, ethylene glycol dimethacrylate, pentaerythritol triallyl ether, trimethylol propane triacrylate or the like. The crosslinkable monomer may be used alone or in combination of two or more kinds. The amount of the crosslinkable monomer may be generally 10 parts by weight or less, preferably 0.1 to 2 parts by weight, with respect to a monovinyl monomer of 100 parts by weight.

Also, it is preferable to use a macromonomer together with the monovinyl monomer since an excellent balance between shelf stability and fixing ability at low temperature can be taken. The macromonomer is a monomer having a polymerizable carbon-carbon unsaturated double bond at the end of a molecular chain, which is an oligomer or polymer generally having a number average molecular weight from 1,000 to 30,000.

As the macromonomer, a macromonomer which forms a polymer having higher glass transition temperature when polymerized than that of a polymer obtained by polymerizing the monovinyl monomer alone is preferable.

The amount of the macromonomer may be generally 0.01 to 3 parts by weight, preferably 0.03 to 2 parts by weight, more preferably 0.05 to 1 parts by weight, with respect to the monovinyl monomer of 100 parts by weight. If the amount of the macromonomer is within the above range, a balance between shelf stability and low-temperature fixing ability may be excellent.

As the polymerization initiator, for example, there may be persulfate such as potassium persulfate, ammonium persulfate or the like; an azo compound such as 4,4′-azobis(4-cyanovaleric acid), dimethyl 2,2′-azobis(2-methylpropionate), 2,2′-azobis(2-methyl-N-(2-hydroxyethyl)propionamide, 2,2′-azobis(2-amidinopropane)dihydrochloride, 2,2′-azobis(2,4-dimethylvaleronitrile), 2,2′-azobisisobutyronitrile or the like; peroxide such as di-t-butylperoxide, benzoylperoxide, t-butylperoxy-2-ethylhexanoate, t-hexylperoxy-2-ethylhexanoate, t-butylperoxypyvalate, di-isopropylperoxydicarbonate, di-t-butylperoxyisophthalate, t-butylperoxyisobutyrate or the like. Also, a redox initiator which is a combination of the polymerization initiator and a reducing agent may be used. Among the above, dimethyl 2,2′-azobis(2-methylpropionate) is preferable.

The amount of the polymerization initiator may be preferably in the range from 0.1 to 20 parts by weight with respect to the polymerizable monomer of 100 parts by weight, more preferably 0.3 to 15 parts by weight, most preferably 0.5 to 10 parts by weight. The polymerization initiator may be preliminarily added to the polymerizable monomer composition, or in some cases, the polymerization initiator may be added to the aqueous dispersion medium after forming droplet.

In the present invention, it is preferable that the dispersion stabilizer is contained in the aqueous medium from the viewpoint of stable dispersion of droplet of the polymerizable monomer composition in an aqueous medium or a colored polymer particle obtained by polymerization thereof, and obtaining a colored polymer particle having a narrow range of distribution of particle size. As the dispersion stabilizer, for example, there may be sulfate such as barium sulfate, calcium sulfate or the like; carbonate such as barium carbonate, calcium carbonate, magnesium carbonate or the like; phosphate such as calcium phosphate or the like; a metal compound such as metal oxide including aluminum oxide, titanium oxide or the like; metal hydroxide such as aluminum hydroxide, magnesium hydroxide, ferric hydroxide or the like; a water-soluble polymer such as polyvinyl alcohol, methyl cellulose, gelatin or the like; an anionic surfactant, a nonionic surfactant, an ampholytic surfactant; or the like. The dispersion stabilizer may be used alone or in combination of two or more kinds.

Among the dispersion stabilizer, a dispersion stabilizer containing a colloid of a metal compound, particularly hardly water-soluble metal hydroxide, is preferable since a particle size distribution of the colored particle can be narrowed, and a residual amount of the dispersion stabilizer after washing is small so that a polymerized toner to be obtained can sharply reproduce an image.

In the number particle size distribution of the colloid of hardly water-soluble metal hydroxide, it is preferable that the particle diameter (Dp 50), whose number-based cumulative total reckoned from the side having smaller particle diameter is 50%, is 0.5 μm or less and the particle diameter (Dp 90), whose number-based cumulative total reckoned similarly as above from the side having smaller particle diameter is 90%, is 1 μm or less. If the diameter of the colloid becomes large, stability of polymerization may decrease as well as stability of the toner for developing electrostatic image may lower.

The amount of the dispersion stabilizer may be preferably in the range from 0.1 to 20 parts by weight with respect to 100 parts by weight of the polymerizable monomer. If the amount of the dispersion stabilizer is below 0.1 parts by weight, it is hard to obtain a sufficient polymerization stability so as to produce a polymerized aggregate. On the other hand, if the amount of the dispersion stabilizer exceeds 20 parts by weight, the particle diameter of the colored particle after polymerization becomes too fine and is not suitable for practical use.

Further, upon polymerization, a molecular weight modifier may be preferably used. As the molecular weight modifier, for example, there may be a mercapto compound such as t-dodecyl mercaptan, n-dodecyl mercaptan, n-octyl mercaptan, 2,2,4,6,6-pentamethylheptane-4-thiol or the like. Among them, 2,2,4,6,6-pentamethylheptane-4-thiol is preferable. The molecular weight modifier can be added prior to initiating polymerization or during polymerization.

The amount of the molecular weight modifier may be preferably in the range from 0.01 to 5 parts by weight with respect to the polymerizable monomer of 100 parts by weight, more preferably 0.1 to 2 parts by weight. If the amount of the molecular weight modifier is within the above range, a balance between shelf stability and low-temperature fixing ability may be excellent, and the zeta potential can be adjusted within the range defined in the present invention.

A method for producing the core-shell structured colored particle using the colored particle may not be particularly limited, and may be produced by a conventional method. For example, there may be a spray dry method, an interface reaction method, an in situ polymerization method, a phase separation method or the like. Specifically, a core-shell structured colored particle is produced by using a colored particle obtained by a pulverization method, a polymerization method, an association method or a phase inversion emulsion method as a core particle, and covering the core particle with a shell layer. Among these methods, the in situ polymerization method and the phase separation method are preferable since production efficiency is high.

The method for producing the core-shell structured colored particle by the in situ polymerization method will be hereinafter described.

The core-shell structured colored particle can be obtained by adding a polymerizable monomer for forming a shell layer (a polymerizable monomer for a shell layer) and the polymerization initiator in the aqueous dispersion medium having the core particle dispersed followed by polymerization.

As the polymerizable monomer for a shell layer, there may be styrene, acrylonitrile or methyl methacrylate, which generates a polymer with glass transition temperature higher than 80° C. if it is polymerized alone. These monomers can be used alone or in a combination thereof.

The amount of the polymerizable monomer for a shell layer is generally 0.1 to 10 parts by weight, preferably 0.5 to 5 parts by weight, more preferably 1 to 3 parts by weight, with respect to the polymerizable monomer of 100 parts by weight used to obtain the polymerizable monomer composition for a core layer.

It is preferable to add a water-soluble polymerization initiator at the time that the polymerization monomer for a shell layer is add since it becomes easier to obtain the colored particle having the core-shell structure. This is because the water-soluble polymerization initiator arrives near the outer surface of the core particle where the polymerizable monomer for a shell layer exists, and the polymer (shell layer) is easily formed on the surface of the core particle when the water-soluble polymerization initiator is added upon adding the polymerizable monomer for a shell layer.

As the water-soluble polymerization initiator, there may be persulfate such as potassium persulfate, ammonium persulfate or the like; an azo initiator such as 2,2′-azobis(2-methyl-N-(2-hydroxyethyl)propionamide), 2,2′-azobis-(2-methyl-N-(1,1-bis(hydroxymethyl)₂-hydroxyethyl)propionamide) or the like. An amount of the water-soluble polymerization initiator may be generally 0.1 to 50 parts by weight with respect to the polymerizable monomer for a shell layer of 100 parts by weight, more preferably 1 to 30 parts by weight.

Polymerization temperature of the core particle and the shell layer may be preferably 50° C. or more, more preferably 60 to 95° C. Also, a reaction time of polymerization may be preferably for 1 to 20 hours, more preferably for 2 to 10 hours. After polymerization, it is preferable to repeat an operation of filtration, washing and dehydration for several times, if required, followed by drying in a conventional manner.

It is preferable for the aqueous dispersion of the colored particle obtained by the polymerization that if an inorganic compound such as inorganic hydroxide or the like is used as the dispersion stabilizer, acid or alkali is added to the aqueous dispersion so as to dissolve the dispersion stabilizer in water and remove. If colloid of hardly water-soluble inorganic hydroxide is used as the dispersion stabilizer, it is preferable to add acid so as to adjust pH of the aqueous dispersion to 6.5 or less. As acid to be added, there may be used inorganic acid such as sulfuric acid, hydrochloric acid, nitric acid or the like, and organic acid such as formic acid, acetic acid or the like. Particularly among them, sulfuric acid is suitable as removing efficiency is high and adverse affect on production facilities is small.

As a method of filtering and dewatering the colored particle from the aqueous dispersion medium, there may not be particularly limited. For example, there may be centrifugal filtration, vacuum filtration, pressure filtration or the like. Among them, the centrifugal filtration is suitable.

The zeta potential of the range defined in the present invention can be attained by combining the case of having kinds and added amount of the release agent, the macromonomer, the molecular weight modifier to be of the specific kinds and within the specific range as described in the present specification, the case of having the colored particle to be a core-shell structured and thickness of the shell layer within a certain range, or the like.

In the case of mixing the external additive, the carrier particle and other fine particles, if required, to the colored particle obtained by the above method, preferably the core-shell structured colored particle, a high speed mixer (product name: Henschel mixer; manufactured by Mitsui Mining Co., Ltd.) or the like may be used to mix.

Hereinafter, an image forming device to which the toner of the present invention is applied will be described in reference to drawings.

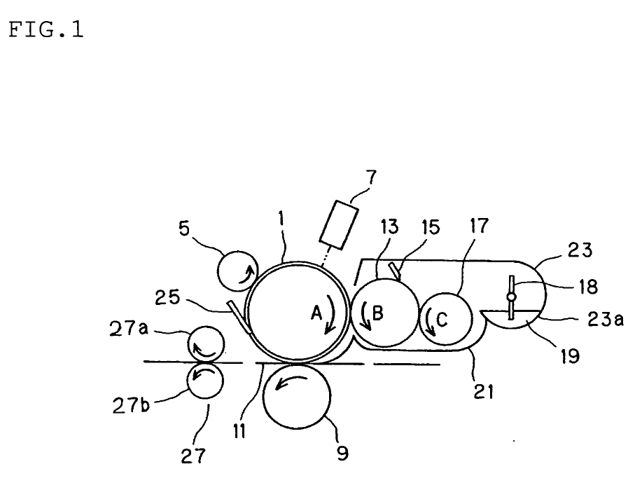

FIG. 1 shows an example of a constitution of an image forming device to which the toner for developing electrostatic image of the present invention is applied. The image forming device as shown in FIG. 1 has a photosensitive dram 1 as a photosensitive member, and the photosensitive dram 1 is mounted so as to be able to rotate freely in the direction of an arrow “A”. The photosensitive dram 1 (photosensitive member) may be preferably a positive charging photosensitive member since the positive charging photosensitive member generates less ozone than a negative charging photosensitive member. The photosensitive dram 1 comprises a conductive support dram member and a photoconductive layer provided on the conductive support dram. The photoconductive layer is formed of, for example, an organic photoconductor, selenium photoconductor, zinc oxide photoconductor, amorphous silicon photoconductor or the like. Among them, the organic photoconductor is preferable. The photoconductive layer is bound to the conductive support dram. As a resin used to bind the photoconductive layer to the conductive support dram, for example, there may be a polyester resin, an acrylic resin, a polycarbonate resin, a phenolic resin, an epoxy resin or the like. Among them, the polycarbonate resin is preferable.

Around the photosensitive dram 1 along the circumferential direction thereof, a charging roll 5 as a charging member, a light radiation device 7 as exposure equipment, a development apparatus 21, a transfer roller 9 and a cleaning blade 25 are arranged.

Also, on the downstream side of the conveying direction of the photosensitive dram 1, a fixing device 27 is provided. The fixing device 27 comprises a heating roller 27a and a support roller 27b.

The conveying route of a transferring material is provided so that the transferring material is conveyed between the photosensitive dram 1 and the transfer roller 9, and between the heating roller 27a and the support roller 27b.

A method of forming an image with the use of the image forming device as shown in FIG. 1 comprises processes of a charging process, an exposuring process, a developing process, a transferring process, a cleaning process and a fixing process as follows.

The charging process is a process to charge positively or negatively the surface of the photosensitive dram 1 uniformly. As the charging method with the use of the charged member, there may be the charging roll 5 as shown in FIG. 1, and also a contact charging method, which uses a fur brush, a magnetic brush, a blade or the like to charge, and a noncontact charging method, which uses corona discharge. It is possible to replace the charging roll 5 by such a contact charging method or noncontact charging method.

The exposuring process is a process to radiate light corresponding to image signal on the surface of the photosensitive dram 1 by means of the light radiation device 7 as an exposure device as shown in FIG. 1, and to form a latent image of electrostatics on the surface of the photosensitive dram 1 charge uniformly. Such a light radiation device 7 comprises, for example, a radiation apparatus and an optical lens.

The developing process is a process to form a visible image (an image of a toner) by attaching the toner for developing electrostatic image to the latent image of electrostatics formed on the surface of the photosensitive dram 1 in the exposuring process by means the development apparatus 21. Bias voltage is applied between the developing roll 13 and the photosensitive dram 1 so that the toner is attached only to a light radiated part in the case of reversal, and the toner is attached only to a light non-radiated part in the case of normal development.

The development apparatus 21 furnished in the image forming device as shown in FIG. 1 is a development apparatus used for a one-component contact developing method, comprising a stirring vane 18, a developing roll 13 and a supply roller 17 in a casing 23 in which a toner 19 is stored.

The stirring vane is furnished in a toner vessel 23a formed on the upperstream side of the toner supply direction of the casing 23.

The developing roll 13 is disposed to partially contact the photosensitive dram 1, and rotates in the opposite direction “B” to the direction of the photosensitive dram 1. The supply roller 17 rotates in the direction “C” similarly to the direction of the developing roll 13 in contact with the developing roll 13. The toner 19 is supplied to the supply roller 17 and is attached to the outer periphery of the supply roller 17. Then, the supply roller 17 supplies the toner 19 to the outer periphery of the developing roll 13. As other developing method, there may be a one-component noncontact developing method, a two-component contact developing method and a two-component noncontact developing method.

Around the developing roll 13, at the position between a contact point of the developing roll 13 with the supply roller 17 and a contact point of the developing roll 13 with the photosensitive dram 1, a blade 15 for the developing roll as a toner layer thickness controlling member is arranged. The blade 15 for the developing roll is made of, for example, a conductive rubber elastic body or metal.

The transferring process is a process to transfer the visible image (the image of the toner) onto the surface of the photosensitive dram 1 formed by means of the development apparatus 21 on the transferring material 11 such as paper or the like so as to form a transferred image (printed image of the toner). Generally, as shown in FIG. 1, transfer is performed by means of the transfer roller 9. However, besides the transfer roller 9, there may be a belt transfer and a corona transfer.

The cleaning process is a process of cleaning the toner not transferred in the transferring process and remained on the surface of the photosensitive dram 1. In the image forming device as shown in FIG. 1, the cleaning blade 25 is used. The cleaning blade may be made of, for example, a rubber elastic body such as polyurethane, acrylonitrile-butadiene copolymer or the like.

In the image forming device as shown in FIG. 1, after the whole surface of the photosensitive dram 1 is uniformly charged negatively by the charging roll 5, a latent image of electrostatics is formed by means of the light radiation device 7. Further an image of the toner is developed by means of the development apparatus 21. Next, the image of the toner on the photosensitive dram 1 is transferred to the transferring material such as paper or the like by means of the transfer roller 9. The toner not transferred and remained on the surface of the photosensitive dram 1 is cleaned by means of the cleaning blade 25. After that, a new image forming cycle begins.

The fixing process is a process to fix the transferred image (the printed image of the toner) transferred to the transferring material 11. In the image forming device as shown in FIG. 1, at least one of the heating roller 27a heated by a heating means (not shown) and the support roller 27b is rotated, and the transferring material 11 passes therethrough so as to be heated and pressed.

The image forming device shown in FIG. 1 is an image forming device for monochrome, however, the toner of the present invention can be applied to a color image forming device such as a copying machine, a printer or the like forming a color image.

### EXAMPLES

The present invention will be explained further in detail with reference to examples. However, the scope of the present invention may not be limited to the following examples. Herein, “part(s)” and “%” are based on weight if not particularly mentioned. Also, an N/N environment refers to an environment at a temperature of 23° C. and a relative humidity of 50%, and an H/H environment refers to an environment at a temperature of 30° C. and a relative humidity of 80%.

[Evaluation Method]

In the examples, a toner is evaluated in the following method.

(1) Particle Diameter, Particle Size Distribution and Average Circle Degree

10 ml of ion-exchanged water was provided in advance into a vessel container, and 0.02 g of a surfactant (alkylbenzen sulfuric acid) was added thereto as a dispersion stabilizer. Then, 0.02 g of a colored particle was added into the vessel and dispersed for 3 minutes by means of an ultrasonic disperser with power of 60 W. 1,000 to 10,000 colored particles of 1 μm or more by a diameter of the equivalent circle were measured by means of a flow type particle projection image analyzer (product name: FPIA-2100, manufactured by Sysmex Corporation), while the toner concentration upon measurement was controlled into the range of 3,000 to 10,000 particles/μL. From the measured values, volume average particle diameter and average circle degree are obtained.

(2) Zeta Potential

Ethanol/ion-exchanged water (solvent having a volume ratio of 50/50; conductivity: 0.8 μS/cm) was added to 30 g of a toner left under the environment at a temperature of 23° C. and a relative humidity of 50% for 1 day (24 hours) to be 100 g, and dispersed for 5 minutes by means of an ultrasonic disperser. Next, zeta potential was measured at 25° C. by mea ns of a zeta potential measurement (product name: Zetasizer 3000HS; manufactured by Malvern Instruments Ltd.). The measured value of a toner just after being dispersed in the solvent was referred as a zeta potential |E|.

(3) Absolute Charge Amount of a Toner on a Developing Roll in an Actual Device (|Q/M|ₐ)

A cartridge, in which a toner is filled and left for 1 day (24 hours) under the N/N environment, was mounted on a commercially available non-magnetic one-component printer (a positively charged organic photoconductive development dram; printing speed: 22 prints (A4 size sheet) per minute). Printing was performed under the N/N environment. After the first sheet was printed by plain pattern printing, the second sheet was halted in the middle of plain pattern printing to measure an absolute charge amount (μC/g) of the toner on the developing roll in an actual device by means of a suction type Q/m analyzer (product name: 210HS-2A; manufactured by TREK JAPAN).

(4) Blowoff Charge Amount (Saturated Absolute Charge Amount (|Q/M|ₛ), Saturated Charge Time)

59.7 g of a carrier particle (product name: NZ-3; manufactured by Powdertech Corporation) and 0.3 g of a toner was charged in a SUS (stainless steel) pod having a capacity of 200 cc and agitated for 30 minutes at rotation of 150 rpm to be frictionally charged. Thus obtained mixture was blownoff at nitrogen pressure of 1 kg/cm by means of a blowoff charge measuring instrument (product name: TB-200; manufactured by Toshiba Chemical Corporation) to measure an absolute charge amount per unit weight.

The blowoff time was increased by 30 seconds (i.e. 30 seconds, 1 minute, 1.5 minutes . . . ) and an absolute charge amount at each blowoff time was measured. Time when increase of absolute charge amount (Q/M) per 30 seconds became 10% or less for the first time was referred as a saturated charge time. From the absolute charge amount at the saturated charge time and the absolute charge amount 30 seconds after the saturated charge time, a mean value was calculated to obtain a saturated absolute charge amount. For example, in the case that Q/M of the blowoff time 5 minutes was 80 μC/g, Q/M of the blowoff time 5.5 minutes was 86 μC/g, and increase of Q/M became 10% or less at blowoff time of 5 to 5.5 minutes for the first time, the saturated time is 5 minutes and the saturated absolute charge amount is a mean value of Q/M of 5 minutes and Q/M of 5.5 minutes, that is 83 μC/g.

(5) Base Value of a THF-Soluble Component of a Toner

After 1 g of a toner is dissolved in 100 ml of tetrahydrofuran (THF) followed by suction filtration by means of a filter paper to remove insolvable components, the obtained solution was further filtered by means of a filter having a pore size of 0.45 μm. Next, the filtrate was titrated with 0.01 N methyl isobutyl ketone (MIBK) perchlorate solution. From the amount of MIBK perchlorate solution required to neutralize, the base value (mgKOH/g) of the toner was obtained. For the titration, an automatic potentiometric titrator (product name: AT-500N; manufactured by Kyoto Electronics Manufacturing Co., Ltd.) with an electrode (product name: #100-C172; manufactured by Kyoto Electronics Manufacturing Co., Ltd.) was used. As 0.01 N MIBK perchlorate solution, 0.1 N dioxane perchlorate solution (for non-aqueous titration, manufactured by Kishida Chemical Co., Ltd.) diluted by MIBK to have 10 times thinner concentration was used. The measurement was performed under nitrogen atmosphere so as to avoid influence of moisture and carbon dioxide in the air.

(6) Acid Value of a THF-Soluble Component of a Toner

After 1 g of a toner e is dissolved in 100 ml of THF followed by suction filtration by means of a filter paper to remove insolvable components, the obtained solution was further filtered by means of a filter having a pore size of 0.45 μm. Next, 20 ml of methyl isobutyl ketone (MIBK) solution of 0.01 N tetrabutyl ammonium hydroxide (TBAH) was added to the filtrate followed by titration with 0.01 N MIBK perchlorate solution. From the amount of MIBK perchlorate solution required to neutralize, the acid value (mgKOH/g) of the toner was obtained. As the MIBK solution of 0.01 N TBAH, 30% methanol solution of TBAH (for non-aqueous titration; manufactured by Tokyo Kasei Kogyo Co., Ltd.) diluted with MIBK was used. As 0.01 N MIBK perchlorate solution, 0.1 N dioxane perchlorate solution (for non-aqueous titration, manufactured by Kishida Chemical Co., Ltd.) diluted by MIBK to have 10 times thinner concentration was used. The titrator used for titration to obtain base value was similarly used as in the above-mentioned (5) and similar operation was performed.

(7) Conductivity

6 g of a toner was dispersed in ion-exchanged water (conductivity σ1: 0.8 μS/cm; pH=7) to be 100 g. Then after the solution was heated to boil for about 10 minutes (boiling time: 10 minutes), separately boiled same ion-exchanged water boiled for about for 10 minutes (conductivity σ1: 0.8 μS/cm; pH=7) was complemented to make same capacity as the capacity before boiling, and cooled to room temperature (around 22° C.). conductivity σ2 of an extract thereof was measured to calculate the difference of conductivity σ2−σ1. The conductivity was measured by means of a conductivity meter (product name: ES-12; manufactured by HORIBA, Ltd.).

(8) Flowability

A toner was left for 1 day (24 hours) under the N/N environment. Next, three kinds of sieves respectively having a pore diameter of 45 μm, 75 μm and 150 μm was piled in this order, on the top of which 4 g of weighted sample (the toner) was placed. Then, the piled three kinds of sieves were shaken under the condition of amplitude at 0.7 mm for 15 seconds by means of a powder measurement (product name: Powder Tester; manufactured by Hosokawamicron Corporation) to measure a mass of the toner remained on each sieve. Each measured value was used in the following equation and referred as a value of flowability. Each sample was measured for 3 times and an average was obtained.

Formula:
a=(mass of toner remained on the sieve having a pore diameter of 150 μm (g))/4 (g)×100
b=(mass of toner remained on the sieve having a pore diameter of 75 μm (g))/4 (g)×100×0.6
c=(mass of toner remained on the sieve having a pore diameter of 45 μm (g))/4 (g)×100×0.2
Flowability (%)=100−(a+b+c)
(9) Image Density (H/H Initial, H/H 2 Weeks)

A photocopying paper was set in a commercially available non-magnetic one-component developing printer (positively charged organic photoconductive development dram; printing speed: 22 prints per minute) and a toner which was left for 1 day (24 hours) under the H/H environment was charged in the development apparatus. Printing of 10 sheets was performed at 5% density under the N/N environment. Plain pattern was printed and the image density of the plain pattern was measured by means of a reflection type image density meter (product name: RD-918; manufactured by McBeth CO., LTD.). The value measured at this stage was referred as an H/H initial image density.

Also, the toner which was left under the H/H environment for two weeks (336 hours) was charged in the development apparatus to measure the image density in the similar environment and procedure as above. The value measured at this stage was referred as an H/H 2 weeks image density.

(10) Initial Fog Value, Environmental Durability

The toner left for 1 day (24 hours) under the N/N environment was charged in the development apparatus of the printer used in the above test (9), and continuous printing was performed at 5% density from the beginning under the N/N environment. Plain pattern printing of 10 sheets was performed as an initial printing, and thereafter for every 500 sheets, and halted in the middle of the plain pattern printing. Then, the toner on a non-image part of the photosensitive member after development was peeled and attached to an adhesive tape (product name: Scotch mending tape 810-3-18; manufactured by Sumitomo 3M Limited) to adhere on a new sheet of printing paper. Whiteness (B) of the adhered sheet of the printing paper was determined by means of a whiteness colorimeter (manufactured by Nippon Denshoku Ind., Co., Ltd.). Similarly, whiteness (A) of a sheet of printing paper solely adhered with the adhesive tape was determined. The difference between the whiteness “A” and “B” (A−B) was referred as a fog value (%). Then number of continuously printed sheet which can maintain an image quality having the fog value of 1% or less was searched and the result was 10,000 sheets. The number of continuously printed sheet measured at this stage was referred as environmental durability (N/N).

Also, the toner left for 1 day (24 hours) under the H/H environment was charged in the development apparatus of the printer used in the above test (9), and continuous printing was performed at 5% density under the H/H environment. 10 sheets were printed as an initial printing and whiteness (C) was measured similarly as the above procedure. The difference between the whiteness “A” of the reference and the whiteness “C” at this point (A−C) was referred as an initial fog value (%).

After measuring the initial fog value, the toner was left for two weeks (336 hours) under the H/H environment as it is. Then, the continuous printing was performed at 5% density under the N/N environment. White plain pattern printing was performed for every 500 sheets of the continuous printing to measure whiteness (D). The difference between the whiteness “A” of the reference and the whiteness “D” (A−D) was referred as a fog value (%). The number of continuously printing sheet which can maintain an image quality having the fog value of 1% or less was searched. The number of continuously printing sheet measured at this stage was referred as environmental durability (H/H).

(11) Thin Line Reproducibility

With the use of the printer used in the above test (9), a line image was formed continuously at 2 dots (plain)×2 dots (black) line (line width: about 85 μm) by the toner left for 1 day (24 hours) under the N/N environment. A density distribution data of the line image was obtained from measurement for every 500 sheets by means of a printing evaluation system (product name: RT2000; manufactured by YA-MA) In this measurement, a part whose density is more than a half of the maximum measured density is regarded as a “line” part.

Thin line reproducibility was evaluated in such a manner that when the difference between the width of the measuring line image and the width of a line image of the first sheet was 10 μm or less, the toner was admitted to have reproduced the line image of the first sheet. Number of sheets which can maintain the difference of width of the line image to be 10 μm or less was searched.

(12) Fixing Temperature of a Toner

A printer modified so that the temperature of a fixing roll part of the printer used in the above test (9) can be changed was used for a fixing test. In the fixing test, while changing the temperature of the fixing roll of the modified printer by 10° C., the fixing rate of the toner was measured at each temperature, thereby, the relationship between fixing temperature and fixing rate was obtained. The fixing rate was calculated from the rate of image density before and after a tape peeling operation of a plain pattern area printed on a test paper by means of the modified printer. That is, when an image density before the tape peeling operation was “ID (before)” and an image density after the tape peeling operation was “ID (after)”, the fixing rate can be calculated from the following formula:
Fixing rate (%)=(ID(after)/ID(before))×100

Herein, the tape peeling operation refers to a series of operations to stick an adhesive tape (product name: Scotch mending tape 810-3-18; manufactured by Sumitomo 3M Limited) on a measuring part of a test paper followed by pressing by means of a 500 g steal roller to attach, and to peel the adhesive tape to the direction along the paper at a constant speed. The image density was measured by means of a reflection type image density meter (product name: RD-918; manufactured by McBeth CO., LTD.). In the fixing test, the lowest fixing roll temperature when the fixing rate was 80% or more was referred to as a fixing temperature of the toner.

(13) Hot Offset Generation Temperature

Similarly as the measurement of the fixing temperature in the above-mentioned test (12), printing was performed while increasing the temperature of the fixing roll by 10° C., the lowest temperature when the toner remained on the fixing roll and soiling was generated was referred as a hot offset generating temperature.

### Production Example 1

Production of a Positive Charge Control Resin “A”

A polymerizable monomer of 100 parts by weight comprising 83% of styrene, 15% of butyl acrylate and 2% of N,N-diethyl-N-methyl-N-(2-methacryloylethyl)ammonium P-toluene sulfonic acid was charged in a mixed solvent comprising 500 parts by weight of toluene and 400 parts of methanol to react at 80° C. under presence of 4 parts by weight of 2,2′-azobismethylvaleronitrile for 8 hours. After reaction, the solvent was removed, thus obtained a quaternary ammonium salt group containing copolymer (hereinafter referred as a positive charge control resin “A”). The weight average molecular weight of the obtained positive charge control resin “A” was 1.2×10⁴, the glass transfer temperature thereof was 67° C., and base value thereof was 0.3 mgKOH/g.

### Example 1

As a polymerizable monomer, 81 parts of styrene and 19 parts of n-butyl acrylate, 7 parts of carbon black (product name: #25BS; manufactured by Mitsubishi Chemical Corporation) as a colorant, and 1.0 part of the positive charge control resin “A” were mixed followed by dispersion treatment at circulation time (θ) of 10 by means of a media type dispersing machine having a separation screen (product name: PICO MILL; manufactured by Asada Iron Works. Co., Ltd.), thus obtained a colorant dispersion. Thereto, 6.0 parts of dipentaerythritol hexamyristate as a release agent, 0.25 parts of a polymethacrylic acid ester macromonomer (product name: AA6; manufactured by TOAGOSEI CO., LTD.), 0.75 parts of divinyl benzene, and 1.85 parts of t-dodecyl mercaptan as a molecular weight modifier were agitated and dissolved under room temperature, thus obtained a polymerizable monomer composition for a core layer.

The time “t” required for one circulation of the dispersion treatment in the media type dispersing machine was obtained from the following formula.
t=W/V

t: time required for one circulation (min/times)

W: absolute charge amount to a holding tank (kg)

V: supply amount of circulation pump (kg/min)

Separately, an aqueous solution of 7.4 parts sodium hydroxide dissolved in 50 parts of ion-exchanged water was gradually added into an aqueous solution of 13.2 parts magnesium chloride dissolved in 215 parts of ion-exchanged water while agitating at room temperature. Thereby, a magnesium hydroxide colloid dispersion liquid was prepared.

The polymerizable monomer composition for a core layer was charged into thus obtained magnesium hydroxide colloid dispersion liquid and agitated until droplets stabilize. When the droplets stabilized, thereto, as a polymerization initiator, 5 parts of t-butylperoxy-2-ethylhexanoate (product name: PERBUTYL O; manufactured by Nihon Yushi Co., Ltd.) was added. Thereafter, a high shear stirring was performed at the rim speed of 40 m/s for 10 minutes by means of an emulsifying and dispersing machine (product name: Ebara MILDER; manufactured by Ebara Corporation) to form droplets of the polymerizable monomer composition for a core layer having smaller diameter.

The magnesium hydroxide colloid dispersion liquid, wherein droplets were formed and the monomer composition for a core layer was dispersed, was charged into a reactor furnished with a stirring vane. A polymerization reaction was performed by raising temperature of the reactor so as to control temperature after reaching 90° C. to be constant. When polymerization conversion rate reached about 100%, 0.7 parts of methyl methacrylate as a polymerizable monomer for a shell layer and 0.42 parts of 2,2′-azobis(2-methyl-N-(2-hydroxyethyl)-propionamide (product name: VA-086; manufactured by Wako Pure Chemical Industries, Ltd.) (polymerization initiator) dissolved in 42 parts of ion-exchanged water were added to the reactor. Polymerization was further continued for 3 hours and reaction was stopped, thus obtained an aqueous dispersion of a core-shell structured colored particle.

The thus obtained aqueous dispersion of the colored particle was subject to acid washing in which pH was adjusted to be 6 or less by sulfuric acid while agitating. After dewatering by filtrating, ion-exchanged water was added again by 500 parts to make a slurry followed by washing with water. Thereafter, similarly, washing with water and dewatering were repeated for several times. After dewatering by filtrating the solid content, drying was performed in a drying machine at 40° C. for two days (48 hours), thus obtained a core-shell structured colored particle. The volume average particle diameter (Dv) of the colored particle was 6.8 μm and the particle size distribution (Dv/Dp) was 1.19. Further, the average circle degree was 0.989.

As external additives, 0.8 parts of a silica particle having hydrophobicity degree of 65% and volume average particle diameter of 12 nm and 1 parts of a silica particle having volume average particle diameter of 50 nm were added to 100 parts of thus obtained colored particle, and mixed by means of a high speed mixer (product name: Henschel mixer; manufactured by Mitsui Mining Co., Ltd.) at 1,400 rpm for 10 minutes, thereby, a toner for developing electrostatic image was obtained.

### Example 2

In the same manner as Example 1 except that 1.2 parts of the positive charge control resin “A” was used instead of 1 part of the positive charge control resin “A” to prepare the polymerizable monomer composition, a toner was obtained.

### Example 3

In the same manner as Example 1 except that 0.5 parts of the positive charge control resin “A” and 8.0 parts of dipentaerythritol hexamyristate were used instead of 1 part of the positive charge control resin “A” and 6.0 parts of dipentaerythritol hexamyristate to prepare the polymerizable monomer composition, a toner was obtained.

### Example 4

In the same manner as Example 1 except that 0.5 parts of the positive charge control resin “A” was used instead of 1 part of the positive charge control resin “A” to prepare the polymerizable monomer composition, and after the aqueous dispersion of the colored particle was subject to acid washing and filtering, further, washing with 0.1% dimethyllaurylbetain aqueous solution (ampholytic surfactant) was performed for surface treatment followed by adding ion-exchanged water again by 500 parts to make a slurry and washing with water, a toner was obtained.

### Comparative Example 1

As a polymerizable monomer for a core layer, 81 parts of styrene, 19 parts of n-butyl acrylate, 0.75 parts of divinyl benzene and 1 part of a polymethacrylic acid ester macromonomer (product name: AA6; manufactured by TOAGOSEI CO., LTD.), 7 parts of carbon black (product name: #25BS; manufactured by Mitsubishi Chemical Corporation) as a colorant, 1.0 part of the positive charge control agent “A”, 10 parts of dipentaerythritol hexamyristate as a release agent and 2.18 parts of t-dodecyl mercaptan as a molecular weight modifier were dispersed at room temperature by means of a media type dispersing machine (product name: DYNO-MILL; manufactured by Shinmaru Enterprises Corporation), thus obtained a polymerizable monomer composition for a core layer.

On the other hand, an aqueous solution of 6.2 parts sodium hydroxide dissolved in 50 parts of ion-exchanged water was gradually added into an aqueous solution of 10.2 parts magnesium chloride dissolved in 250 parts of ion-exchanged water while agitating. Thereby, a magnesium hydroxide colloid dispersion liquid was prepared.

1.3 parts of methyl methacrylate and 65 parts of water were mixed, thus obtained an aqueous dispersion liquid of a polymerizable monomer for a shell layer.

The polymerizable monomer composition for a core layer was charged into thus obtained magnesium hydroxide colloid dispersion liquid and agitated until droplets stabilize. Thereto, as a polymerization initiator, 5 parts of t-butylperoxy-2-ethylhexanoate (product name: PERBUTYL O; manufactured by Nihon Yushi Co., Ltd.) was added. Thereafter, a high shear stirring was performed at 15,000 rpm for 30 minutes by means of an in-line type emulsifying and dispersing machine (product name: Ebara MILDER; manufactured by Ebara Corporation) to form droplets of the polymerizable monomer composition for a core layer having smaller diameter, thus obtained a suspension.

The suspension was charged into a reactor furnished with a stirring vane. A polymerization reaction was performed by raising temperature of the reactor so as to control temperature after reaching 90° C. to be constant. When polymerization conversion rate reached about 100%, the aqueous dispersion liquid of the polymerizable monomer for a shell layer and 0.3 parts of 2,2′-azobis(2-methyl-N-(2-hydroxyethyl)-propionamide (product name: VA-086; manufactured by Wako Pure Chemical Industries, Ltd.) (polymerization initiator) dissolved in 20 parts of ion-exchanged water were added to the reactor. Polymerization was further continued for 4 hours and reaction was stopped, thus obtained an aqueous dispersion of a core-shell structured colored particle. The thus obtained aqueous dispersion of the colored particle was subject to acid washing in which pH was adjusted to be 4 or less by sulfuric acid while agitating. After dewatering by filtrating, further washing with water and dewatering were repeated for several times. After dewatering by filtrating the solid content, drying was performed in a drying machine at 45° C. for two days (48 hours), thus obtained a core-shell structured colored particle. The volume average particle diameter (Dv) of the colored particle was 7.1 μm and the particle size distribution (Dv/Dp) thereof was 1.14. Further, the average circle degree was 1.12.

As an external additive, 1 part of a silica particle (product name: HDK2150; manufactured by Clariant Japan Corp.) was added to 100 parts of thus obtained core-shell structured colored particle, and mixed by means of a high speed mixer (product name: Henschel mixer; manufactured by Mitsui Mining Co., Ltd.) at rim speed of 30 m/s for 5 minutes, thereby, a toner was obtained.

### Comparative Example 2

In the same manner as Example 1 except that a media type dispersing machine (product name: DYNO-MILL; manufactured by Shinmaru Enterprises Corporation) and no charge control agent was used instead of the media type dispersing machine (product name: PICO MILL; manufactured by Asada Iron Works. Co., Ltd.) for dispersion treatment of the colorant dispersion, a toner was obtained.

### Comparative Example 3

In the same manner as Example 1 except that 8 parts of carbon black (product name: #25BS; manufactured by Mitsubishi Chemical Corporation) as a colorant, a media type dispersing machine (product name: DYNO-MILL; manufactured by Shinmaru Enterprises Corporation), 10 parts of dipentaerythritol hexamyristate for preparing the polymerizable monomer composition, 2.0 parts of a polymethacrylic acid ester macromonomer (product name: AA6; manufactured by TOAGOSEI CO., LTD.), 1.75 parts of t-dodecyl mercaptan as a molecular weight modifier and 2 parts of methyl methacrylate (polymerizable monomer for a shell layer) were used, whereas in Example 1, 7 parts of carbon black (product name: #25BS; manufactured by Mitsubishi Chemical Corporation) as a colorant, a media type dispersing machine (product name: PICO MILL; manufactured by Asada Iron Works. Co., Ltd.), 6.0 parts of dipentaerythritol hexamyristate for preparing the polymerizable monomer composition, 0.25 parts of a polymethacrylic acid ester macromonomer (product name: AA6; manufactured by TOAGOSEI CO., LTD.), 1.85 parts of t-dodecyl mercaptan as a molecular weight modifier and 0.7 parts of methyl methacrylate (polymerizable monomer for a shell layer) were used, a toner was obtained.

The toner for developing electrostatic image obtained in Examples 1 to 4 and Comparative examples 1 to 3 were evaluated as aforementioned. The evaluation results are shown in Table 1.

TABLE 1

| | | Example 1 | Example 2 | Example 3 | Example 4 |
|---|---|---|---|---|---|
| Binder resin (ST/BA/DVB) (*1) | | 81/19/0.75 | 81/19/0.75 | 81/19/0.75 | 81/19/0.75 |
| Release agent (dipentaerythritol hexamyristate) (*2) | | 6 Phr | 6 Phr | 8 Phr | 6 Phr |
| Colorant (Carbon black #25BS) (*2) | | 7 Phr | 7 Phr | 7 Phr | 7 Phr |
| Charge control agent (Positive charge control resin “A”) | | 1.0 | 1.2 | 0.5 | 0.5 |
| Pigment dispersion means | | PICO MILL | PICO MILL | PICO MILL | PICO MILL |
| Molecular weight modifier (t-dodecyl mercaptan) | | 1.85 | 1.85 | 1.85 | 1.85 |
| Polymerizable monomer for shell layer (MMA) (*1) | | 0.7 | 0.7 | 0.7 | 0.7 |
| Polymethacrylic acid ester macromonomer | | 0.25 | 0.25 | 0.25 | 0.25 |
| Post treatment | | none | none | none | Surface treatment |
| Charge amount of toner on developing roll in actual device | | 52 | 61 | 31 | 28 |
| \|Q/M\|ₐ (μC/g) | | | | | |
| Zeta potential \|E\| (mV) | | 4.8 | 5.42 | 2.2 | 0.4 |
| Saturated charge time (min) | | 1.5 | 2 | 2 | 2 |
| Saturated absolute charge amount \|Q/M\|ₐ (μC/g) | | 67 | 88 | 47 | 42 |
| Volume average particle diameter (μm) | | 6.8 | 6.3 | 6.6 | 6.7 |
| Average circle degree | | 0.975 | 0.980 | 0.980 | 0.980 |
| Acid value of THF-soluble component of toner (mgKOH/g) | | 0.10 or less | 0.10 or less | 0.10 or less | 0.10 or less |
| Base value of THF-soluble component of toner (mgKOH/g) | | 0.3 | 0.4 | 0.2 | 0.2 |
| Flowability | N/N | 85 | 82 | 80 | 88 |
| Image density | H/H initial | 1.42 | 1.38 | 1.4 | 1.35 |
| | H/H 2 weeks | 1.25 | 1.1 | 1.25 | 1.16 |
| Initial fog value (%) | H/H | 0 | 1 | 0 | 0 |
| Environmental durability | N/N | 10,000 | 10,000 | 10,000 | 10,000 |
| (fog for 1% or less) (sheets) | H/H | 8,500 | 8,500 | 8,500 | 9,000 |
| Thin line reproducibility (sheets) | N/N | 10,000 | 10,000 | 10,000 | 10,000 |
| Fixing temperature (° C.) | N/N | 140 | 140 | 140 | 140 |
| Hot off set generating temperature (° C.) | N/N | 210 | 210 | 210 | 210 |

| | | Comparative | Comparative | Comparative |
|---|---|---|---|---|
| | | example 1 | example 2 | example 3 |
| Binder resin (ST/BA/DVB) (*1) | | 81/19/0.75 | 81/19/0.75 | 81/19/0.75 |
| Release agent (dipentaerythritol hexamyristate) (*2) | | 10 Phr | 6 Phr | 10 Phr |
| Colorant (Carbon black #25BS) (*2) | | 7 Phr | 7 Phr | 8 Phr |
| Charge control agent (Positive charge control resin “A”) | | 1.0 | 0 | 1.0 |
| Pigment dispersion means | | DYNO-MILL | DYNO-MILL | DYNO-MILL |
| Molecular weight modifier (t-dodecyl mercaptan) | | 2.18 | 1.85 | 1.75 |
| Polymerizable monomer for shell layer (MMA) (*1) | | 1.3 | 0.7 | 2.0 |
| Polymethacrylic acid ester macromonomer | | 1.00 | 0.25 | 2.00 |
| Post treatment | | none | none | none |
| Charge amount of toner on developing roll in actual device | | 48 | 1 | 55 |
| \|Q/M\|ₐ (μC/g) | | | | |
| Zeta potential \|E\| (mV) | | 12.4 | 5.4 | 18.4 |
| Saturated charge time (min) | | 3 | 9 | 3.5 |
| Saturated absolute charge amount \|Q/M\|ₐ (μC/g) | | 56 | 10 | 73 |
| Volume average particle diameter (μm) | | 6.8 | 6.7 | 7.1 |
| Average circle degree | | 0.970 | 0.970 | 0.970 |
| Acid value of THF-soluble component of toner (mgKOH/g) | | 0.10 or less | 0.10 or less | 0.10 or less |
| Base value of THF-soluble component of toner (mgKOH/g) | | 0.6 | 0.1 | 1.3 |
| Flowability | N/N | 68 | — | 70 |
| Image density | H/H initial | 1.26 | 0.8 | 1.25 |
| | H/H 2 weeks | 1.13 | 0.6 | 1.1 |
| Initial fog value (%) | H/H | 8 | 18 | 6 |
| Environmental durability | N/N | 8,500 | — | 8,500 |
| (fog for 1% or less) (sheets) | H/H | 7,500 | — | 7,000 |
| Thin line reproducibility (sheets) | N/N | 9,000 | 500 or less | 9,000 |
| Fixing temperature (° C.) | N/N | 140 | 140 | 140 |
| Hot off set generating temperature (° C.) | N/N | 200 | 210 | 200 |
| (*1) Abbreviations of polymerizable monomers for a binder resin and a polymerizable monomer for a shell layer are as follows: ST (styrene), BA (n-butyl methacrylate), DVB (divinyl benzene), MMA (methyl methacrylate). | | | | |
| (*2) Phr: a weight ratio of the compound with respect to a binder resin for a core layer of 100 parts. However, in the weight of the binder resin for a core layer, the crosslinkable monomer and the macromonomer type polymerizable monomer may not be included. | | | | |
| # For example, in Example 1, the crosslinkable DVB component contained in the binder resin and MMA contained in the monomer for a shell layer are excluded so that the total amount of ST and BA is considered to be 100 parts upon calculating Phr. | | | | |

[Summary of the Test Results]

From the evaluation results of the toner for developing electrostatic image in Table 1, followings can be understood.

The toners obtained in Examples 1 to 4 are excellent in flowability, hot offset temperature and thin line reproducibility under storage environment at normal temperature. As for the toner properties due to leaving environment (N/N environment and H/H environment), the toners obtained in Examples 1 to 4 have small initial fog value, excellent environmental durability and comprehensively high image density.

To the contrary, the toners obtained in Comparative example 1, wherein the zeta potential was out of the range defined in the present invention, and Comparative example 3, wherein the zeta potential and base value were out of the range defined in the present invention, were insufficient in the above properties. Also, the toner obtained in Comparative example 2, wherein the absolute charge amount of the toner on the developing roll in an actual device, saturated charge time and the saturated absolute charge amount were out of the range defined in the present invention, was more insufficient in the above properties.

What is claimed is:

1. A toner for developing electrostatic image comprising a colored particle containing a binder resin, a colorant, a release agent and a charge control agent,
wherein an absolute charge amount of the toner on a developing roll in an actual device |Q/M|ₐ is in the range from 20 to 100 μC/g and
a zeta potential |E| is 10 mV or less
after laying still for 24 hours under environment at a temperature of 23° C. and a relative humidity of 50%.

2. The toner for developing electrostatic image according to claim 1,
wherein the toner for developing electrostatic image has a positive charging property.

3. The toner for developing electrostatic image according to claim 1,
wherein a saturated absolute charge amount |Q/M|ₛ of the toner for developing electrostatic image is in the range from 30 to 120 μC/g and a saturated charge time of the toner for developing electrostatic image is 5 minutes or less.

4. The toner for developing electrostatic image according to claim 1,
wherein a volume average particle diameter (Dv) of the colored particle is in the range from 4 to 10 μm and an average circle degree of the colored particle is in the range from 0.950 to 0.995.

5. The toner for developing electrostatic image according to claim 1,
wherein the charge control agent is a charge control resin, and
each of base value and acid value of a THF-soluble component of the toner for developing electrostatic image is 1 mgKOH/g or less.

6. The toner for developing electrostatic image according to claim 5,
wherein a base value of the charge control resin is 1.5 mgKOH/g or less.

7. The toner for developing electrostatic image according to claim 1,
wherein the charge control agent is a charge control resin, and
the charge control resin is a copolymer containing a quaternary ammonium group.

8. The toner for developing electrostatic image according to claim 1,
wherein the colored particle is a core-shell structured particle.

9. A method of forming an image comprising processes of:
a developing process to form a visible image by attaching a toner for developing electrostatic image to a latent image of electrostatics formed on a photosensitive member;
a transferring process to transfer the visible image onto a transferring material so as to form a transferred image; and
a fixing process to fix the transferred image, wherein
the toner for developing electrostatic image comprises a colored particle containing a binder resin, a colorant, a release agent and a charge control agent;
an absolute charge amount of the toner on a developing roll in an actual device |Q/M|ₐ is in the range from 20 to 100 μC/g; and
a zeta potential |E| is 10 mV or less
after laying still for 24 hours under environment at a temperature of 23° C. and a relative humidity of 50%.

10. A method of forming an image according to claim 9,
wherein the photosensitive member is a positive charging photosensitive member.
